(19) United States
(12) Patent Application Publication
(10) Pub. No.: US 2023/0110209 A1
(43) Pub. Date: Apr. 13, 2023

(54) A BEVERAGE BREWING DEVICE

(71) Applicant: Conopco, Inc., d/b/a UNILEVER, Englewood Cliffs, NJ (US)

(72) Inventors: Simon Lewis BILTON, Leamington Spa (GB); Nathan James BATES, Leighton Buzzard (GB); Benedict William Flynn TAYLOR, Leamington Spa (GB); Richard James THOMAS, London (GB)

(21) Appl. No.: 17/767,666

(22) PCT Filed: Nov. 6, 2020
(86) PCT No.: PCT/EP2020/081298

§ 371 Date: Apr. 8, 2022

(30) Foreign Application Priority Data
Nov. 18, 2019 (EP) 19209719.4

(51) Int. Cl. A47J 31/20; A47J 31/44

(52) U.S. Cl. CPC A47J 31/20; A47J 31/4403

(57) ABSTRACT

A beverage brewing device includes a brew chamber and a plunger. The brew chamber includes at least one water permeable portion and an openable base. The plunger includes a plunger face corresponding to an internal shape of the brew chamber. The openable base is openable by action of the plunger.

### TECHNICAL FIELD OF THE INVENTION

The present invention relates to a beverage brewing device. In particular, the present invention relates to a beverage brewing device that can eject used infusion material from the brew chamber in a clean, simple and effective manner.

### BACKGROUND TO THE INVENTION

Infusion packets, such as tea bags, are used throughout the world. The packets comprise infusion material such as tea or coffee within a water permeable packet. Once used, infusion packets are disposed of into the household or industrial refuse systems and represent a significant waste stream, most of which is not sent for recycling/biodegradation but is instead sent to landfill, incineration, or other non-sustainable refuse management approaches.

The present invention is therefore directed to reducing the use and subsequent disposal of infusion packets by providing a beverage brewing device that does not require the infusion material to be provided within a water permeable packet. Instead the infusion material is placed directly into the device, the device is then used to brew a beverage, and the used infusion material is removed from the device. Water permeable packet material is not required, and the used infusion material can therefore be placed directly into domestic or industrial composting streams.

Beverage brewing devices are known in the art.

GB 2 249 021 discloses an infusion device for location within a container holding a fluid comprising a receptacle for holding the substance to be infused, a filter housing, one end of which is connected to the receptacle, and a plunger which is moveable within the filter housing from a first position in which the substance is free to react with the surrounding fluid to a second position which seals the substance in the receptacle from the surrounding fluid. When a preferred embodiment is in use, the receptacle is secured to the filter housing and the substance to be infused is introduced into the receptacle via the open end of filter housing. In this embodiment, the filter housing is provided with a protrusion which protrudes outwardly and will co-operate with an L-shaped groove in the receptacle when the filter housing and receptacle are pushed together as a sliding fit. The receptacle is secured to the filter housing by twisting the parts with respect to each other and can be removed for cleaning purposes.

FR 2 740 315 discloses a percolator having a cylinder, made of plastics material, with a circular ring on its inner surface. Its lower end has a screw thread on to which a sleeve is screwed. This holds a capsule, containing ground coffee, that is held by the inner ring. The cylinder is filled with hot or cold water and a piston, with a watertight joint, is put into it. This is pushed down, by its head, to force water through the coffee.

WO 01/34002 discloses an infuser for creating an infused drink, the infuser comprising a handle, the handle carrying at one end a receptacle adapted to receive a material to be infused, the receptacle being such that when the receptacle is immersed in water, the material to be infused is acted upon by the water.

WO 2007/080461 discloses a device for preparing a beverage extract from a charge of particulate material, the device including: a foraminous body defining a cylindrical passage with a closed end; and a plunger displaceable along the passage, thereby to exert pressure on a charge of particulate material received in use between the plunger and the closed end of the passage. The foraminous body may include a removable closure member defining the closed end of the passage. In one embodiment the closure member is removably engageable with the wall by means of a bayonet type connection.

GB 208,199 discloses a tea or like infuser comprising a perforated receptacle, a lid or cover at one end thereof, a handle at the other end thereof and a solid or imperforate plunger or presser plate in opposed relationship to the lid or cover and carried at one end of a rod slidable through said handle. In a construction illustrated therein, in operation the receptacle is supplied with a predetermined quantity of tea through a hinged or other lid or cover which is then closed. The lid may be provided with a catch of any suitable type for holding the lid closed. The lid or cover may also, instead of being hinged, be slidable or removable, in which latter case it may be held in position by a bayonet or other suitable fastening.

None of the aforementioned pieces of prior art make any mention of the expulsion of spent infusion material. Indeed, none of the aforementioned pieces of prior art are capable of providing for the expulsion of spent infusion material.

GB 2 214 785 discloses a device for use in the infusion of a substance capable of forming a beverage with a liquid, which device comprises: a main body which is provided with a chamber adapted to accommodate the substance and which is also provided with one or more apertures which, when the main body is at least partially submerged in liquid, allows liquid to pass into and out of the chamber; and a plunger which is at least partially received within the main body and which is movable within the chamber to a first position in which it is capable of compressing a substance contained therein. In one embodiment of the invention the container includes an apertured body and an apertured base. The apertured base can be push fitted snugly over the lower, open end of the body. The apertured base has two diametrically opposed bayonet-type slots. When the base is fitted on to the body, lugs on the body are engaged in the bayonet-type slots of the base. To use the device, the base is removed from the body and a tea bag is mounted in the latter. The base is then replaced, and the device placed in a cup. When no further infusion from the tea can take place, the device is removed from the cup in which it is being used, and the base is then removed. By further use of the handle and plunger, the tea bag can be ejected into a waste disposal container. It will be appreciated that this device is specifically directed to the ejection of a tea bag as opposed to loose infusion material. Moreover, the base must be removed by hand before the tea bag can be ejected.

U.S. Pat. No. 790,626 discloses a device for making infusions comprising a tubular casing for containing the substance to be infused and provided with a perforated end, a plunger movable in the casing and projecting at its outer end beyond the same, and a perforated cap hinged on the perforated end of the casing for opening or closing the perforated end. In case the casing is completely filled with tea-leaves and a number of cups of tea have been made, then the operator opens the cap and pushes the plunger inward about half the length of the casing, so as to discharge the lower half portion of the tea leaves from the casing, and then the cap is again closed and the device used further for making more cups of tea. Again, it will be appreciated that the operator must open the cap by hand before any tea leaves can be discharged.

Despite the attempts of the prior art above to provide beverage brewing devices that can eject infusion material from the brew chamber, none of them provide a device that can be used cleanly, simply and effectively without the need for the operator to manually open the brew chamber to remove the infusion material. There therefore remains the need for an improved beverage brewing device that overcomes these issues.

### SUMMARY OF DRAWINGS

FIG. 1 shows in cross section an embodiment of the present invention.

FIG. 2 shows detail of the openable base of the embodiment of FIG. 1.

FIG. 3 shows the embodiment of FIG. 1 and provides detail of the plunger interacting with the openable base just prior to opening.

FIG. 4 shows the embodiment of FIG. 1 with the plunger fully depressed and the openable base open.

### SUMMARY OF INVENTION

We have now found that a specifically configured brewing device addresses the foregoing issues.

Accordingly, the present invention provides a beverage brewing device comprising,
a brew chamber comprising at least one water permeable portion, and
a plunger, the plunger having a plunger face corresponding to the internal shape of the brew chamber;
the chamber having an openable base; and
characterised in that the openable base is openable by action of the plunger.

Preferably the brew chamber is cylindrical.

Preferably the brew chamber has a height of from 5-20 cm.

Preferably the at least one water permeable portion of the brew chamber is formed by apertures or windows in the walls of the brew chamber covered with foraminous material.

Alternatively, the at least one water permeable portion of the brew chamber is formed from openings.

Preferably the openings are pores, perforations, holes or a combination thereof.

Preferably the at least one water permeable portion has a height of from 10-75% of the height of the brew chamber.

Preferably the length of the plunger is greater than the length of the brew chamber.

Preferably the outer edge of the plunger face is provided with a flexible material to provide a seal.

Preferably the openable base is held closed by a friction fit closing means.

Preferably the openable base comprises a door.

Preferably the door is held closed by means of a friction fit.

Preferably the door is hinged.

Preferably the hinge is positioned opposite the closing means.

Preferably the internal face of the openable base is sloped.

Preferably the internal face slopes downwards towards the hinge.

Preferably the internal face slopes downwards away from the closing means.

Preferably the internal face slope downwards away from the closing means towards the hinge.

Preferably the openable base has openings.

Preferably the openings are perforations, holes, channels or combinations thereof.

### DETAILED DESCRIPTION OF INVENTION

In use, the beverage brewing device of the invention typically operates as follows. With the openable base of the brew chamber closed, an infusible material—such as tea, coffee, tisane, herbal infusion, or the like—is placed in the brew chamber. The plunger is inserted into the top of the brew chamber and the brewing device is placed in a brewing vessel—such as a cup, mug, flask, teapot, coffee pot, or the like—to which water is added. The water enters the brew chamber via the water permeable portions and the infusible material is allowed to brew. When brewing has finished, the plunger is pushed downwards towards the openable base (which is still in the closed position) thereby squeezing out the brew liquor and creating a compressed mass of used infusible material herein referred to as a “puck”. The brewing device is removed from the brewing vessel, the plunger is pushed further, and the openable base is opened by the action of the plunger. The puck of used infusible material then is ejected from the brew chamber via the now open base and as the face of the plunger protrudes through the open end of the chamber the puck falls away, typically into a waste receptacle. The protrusion of the plunger face also facilitates rinsing and removal of any final remains of the infusion material.

### Brew Chamber

The brew chamber may be of any suitable shape, preferably cylindrical. The brew chamber has two ends. The openable base is located at one end. The other end provides an opening through which infusible material may be placed into the brew chamber and into which the plunger is located.

The brew chamber may be formed from any suitable material such as metal, glass or plastic. Bioplastics may be used. Recycled or recyclable plastic is preferred. The brew chamber may have a height of from 5-20 cm, preferably 10-15 cm and a width of from 1-10 cm, preferably 2-6 cm.

The at least one water permeable portion of the brew chamber may be formed by apertures or windows in the walls of the brew chamber covered with any suitable foraminous materials such as mesh material, filter material, or perforated material. The water permeable portion may also be formed from openings such as pores, perforations, holes and the like. The water permeable portion provides fluid communication through the walls of the brew chamber itself. The size of the openings in the water permeable portion may be of any suitable size known to the skilled person such that the size is small enough to retain the infusion materials placed within the brew chamber but large enough to allow liquid to enter the brew chamber and achieve effective brewing. Preferably the openings are circular. Preferably the openings have a width of at most 2 mm, more preferably at most 1.75 mm, more preferably still at most 1.5 mm, yet more preferably at most 1.25 mm, even more preferably at most 1 mm, more preferably still at most 0.75 mm, preferably at most 0.5 mm, yet more preferably at most 0.25 mm, more preferably still at most 0.2 mm, most preferably at most 0.1 mm. Preferably the openings have a width of at least 0.001 mm, more preferably at least 0.005 mm, more preferably still at least 0.01 mm, most preferably at least 0.05 mm.

The at least one water permeable portion may be of any suitable size but preferably has a height of from 10-75% of the height of the brew chamber, more preferably 20-50%. Preferably the at least one water permeable portion is located in the mid region of the brew chamber. In a preferred embodiment, the area of the brew chamber proximal to the openable base is not porous which prevents dripping.

### Plunger

The plunger may be any object whose shape corresponds to the internal shape of the brew chamber. For example, if the chamber is cylindrical, the plunger may be tubular wherein the base of the tube forms the face of the plunger. The plunger may also be in the form of a shaft upon which is provided a plunger face. In all cases the plunger face corresponds to the internal shape of brew chamber—for example, if the chamber is cylindrical, the plunger face is circular and corresponds to the circular cross section of the inside of the brew chamber. The other end of the plunger may be formed as a foot or base such that the device can be stored standing inverted on the end of the plunger.

The length of the plunger is preferably greater than the length of the brew chamber. This enables the plunger face to protrude through the opened base to facilitate rinsing and removal of any final remains of infusion material from the plunger.

The outer edge of the plunger face is preferably provided with a flexible material to provide a seal between the outer edge of the plunger face and the inner face of the brew chamber. For example, the plunger face may have a flexible silicone outer edge mounted upon a rigid plastic disc that forms the plunger face, and the rigid plastic disc may be mounted on a plunger shaft.

### Openable Base

The openable base may be integral to the brew chamber or it may be formed from a separate module that is attached to the brew chamber. The openable base may be formed from any suitable material such as metal or plastic. Bioplastics may be used. Recycled or recyclable plastic are preferred. Where the openable base is formed from a separate module, the size and shape of the openable base corresponds to the size and shape of the end of the brew chamber to which it is to be attached.

The openable base may be held closed by any suitable closing means such as a friction fit, a magnetic closure, a clip, or the like. Preferably the openable base is held closed by means of a friction fit.

The base opens because of the action of the plunger face pushing against the inner face of the openable base. The openable base preferably comprises a door which is pushed open by the plunger. A sealing ring may be provided around the door to seal the openable base when closed. The door may be held closed by any suitable closing means such as a friction fit, a magnetic closure, a clip, or the like. Preferably the door is held closed by means of a friction fit. Preferably the door is hinged. Preferably the door opens to an angle of at least 90° relative to the closed position, more preferably 110°, more preferably 130°, more preferably 150°, more preferably 170° relative to the closed position. Preferably the hinge is sprung to hold the door in the open position when opened. Preferably, the hinge is positioned opposite the closing means.

Preferably the internal face of the openable base is sloped. The upper end of the slope interacts with the plunger face to ensure the openable base is openable by action of the plunger. Where the openable base has a hinged door the slope preferably slopes downwards towards the hinge. Where the openable base has a closing means the slope preferably slopes downwards away from the closing means. Where the openable base has a hinged door and a closing means the slope preferably slopes downwards from the closing means towards the hinge.

The openable base may have openings such as perforations, holes, channels and the like that provide fluid communication through the openable base. The size of the openings in the water permeable portion may be any suitable size such that inclusion materials are retained while liquid may pass through to achieve effective brewing. The openings also provide for the expulsion of brew liquor from the infusion material as the infusion material is compressed by the action of the plunger. This facilitates formation of the puck of infusion material for subsequent expulsion from the brewing device. Preferably the openings are circular. Preferably the openings have a width of at most 2 mm, more preferably at most 1.75 mm, more preferably still at most 1.5 mm, yet more preferably at most 1.25 mm, even more preferably at most 1 mm, more preferably still at most 0.75 mm, preferably at most 0.5 mm, yet more preferably at most 0.25 mm, more preferably still at most 0.2 mm, most preferably at most 0.1 mm. Preferably the openings have a width of at least 0.001 mm, more preferably at least 0.005 mm, more preferably still at least 0.01 mm, most preferably at least 0.05 mm.

Alternatively, the openable base may have no holes which helps prevents dripping when the brewing device is removed from the brewing vessel.

Preferably the openable base has a flat base to allow the brewing device to stand upright either when in use, during cleaning, rinsing and drying, and when stored.

The beverage brewing device of the present invention will now be further elucidated with reference to the Figures. For ease of interpretation, the infusible material is not shown in the Figures.

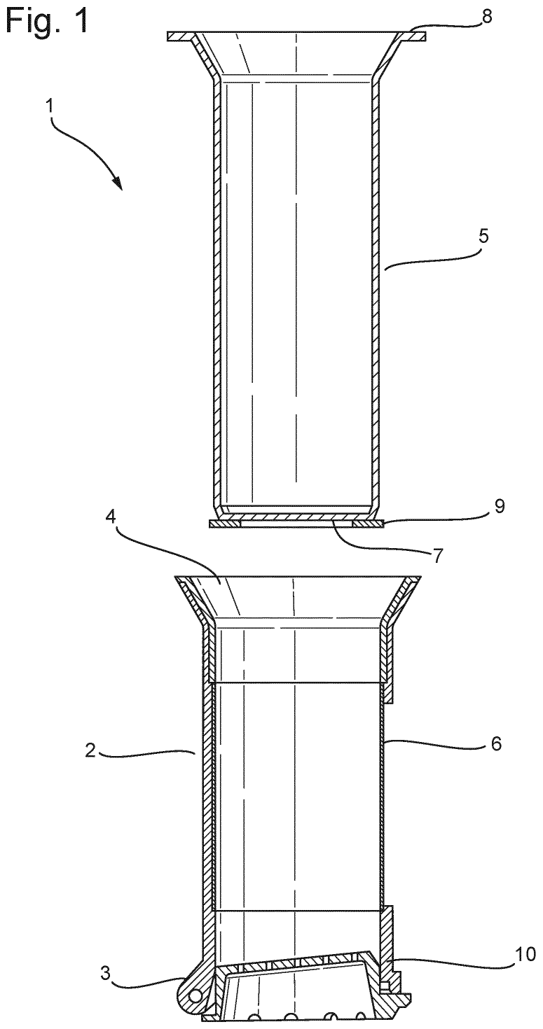

FIG. 1 shows a sectional side view of a beverage brewing device 1 according to the invention in which the plunger 5 and brew chamber 2 are separated. The beverage brewing device 1 has a cylindrical brew chamber 2. The openable base 3 is located at one end. The other end provides the opening 4 through which infusible material may be placed into the brew chamber 2 and into which the plunger 5 is located.

In this embodiment, the water permeable portion 6 of the brew chamber is formed as a window in the wall of the brew chamber 2 that is covered with a filter material. The area of the brew chamber 2 proximal to the openable base 3 is not water permeable.

The plunger 5 is tubular to correspond with the internal shape of the brew chamber 2 and the base of the tube forms the plunger face 7. The other end 8 of the plunger 5 is formed such that the device can be stored standing inverted on the plunger. As can be seen, the length of the plunger 5 is greater than the length of the brew chamber 2 which will enable the plunger face 7 to protrude through the opened base 3 to facilitate rinsing and removal of any final remains of the infusion material from the plunger 5. The outer edge of the plunger face 7 has an annular seal 9 to form a seal between the plunger face 7 and the brew chamber 2.

The openable base 3 is integral to the brew chamber 2 and is held closed by a friction fit closure 10.

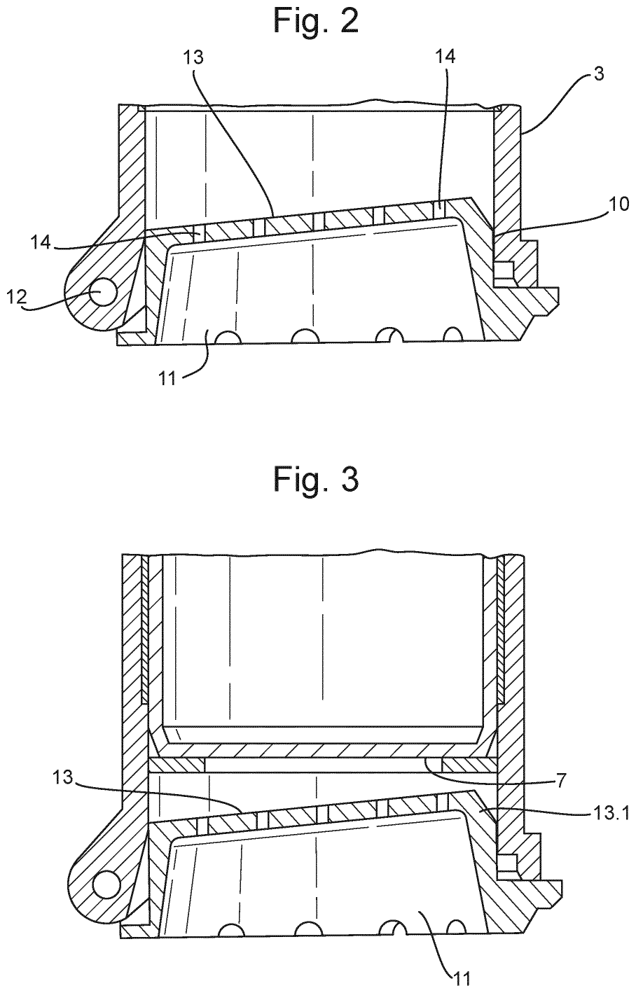

As shown in FIG. 2, the openable base 3 has a door 11 with a hinge 12. The door is held closed by friction fit 10. The internal face 13 of the openable base 3 is sloped from the friction fit side 10 downwards to the hinge side 12. The door 11 of the openable base 3 has holes 14 that enable the expulsion of brew liquor from the infusion material as the infusion material is compressed by the action of the plunger 5.

With reference to the Figures, the brewing device 1 of the present invention is used as follows.

With the openable base 3 of the brew chamber 2 closed, an infusible material such as tea, coffee, tisane, a herbal infusion, or the like is placed in the brew chamber 2 via the opening 4. The plunger 5 is then placed into the chamber 2 via the opening 4 but it is not fully depressed at this point in order to allow space in the brew chamber 2 for brewing.

The brewing device 1 is then placed in a brewing vessel such as a cup, mug, flask, teapot, coffee pot, or the like. Water (or other such brew liquor) is added to the brewing vessel either before or after the brewing device 1 is placed in the brewing vessel.

The water enters the brew chamber 2 via the water permeable portions 6 and the holes 14 in the openable base 3 and the infusible material is allowed to brew. The brewing device 1 can be moved within the brewing vessel by agitation, stirring and the like to facilitate brewing.

When brewing has finished, the brewing device 1 stands in the brewing vessel and is maintained in an upright position due to the flat base of the openable base 3. The plunger is pushed downwards towards the openable base (which is still in the closed position) thereby creating a mass of used infusible material. It will be appreciated that during this movement, any force exerted on the openable base 3 by the plunger 5 is abutted by the base of the brewing vessel and the openable base 3 remains closed, the used infusible material is squeezed into a puck and the brew liquor is expelled by the action of the plunger through the water permeable portions 6 and the holes 14.

The brewing device 1 is then removed from the brewing vessel, typically using the end of the plunger as a handle. The brewing device 1 is then held over a waste receptacle and the plunger is pushed downwards further to force open the openable base. Through the action of the plunger, the puck of used infusible material is ejected from the brew chamber 2 via the open base 3. In doing so, the puck adheres to plunger face 7, not the openable base itself.

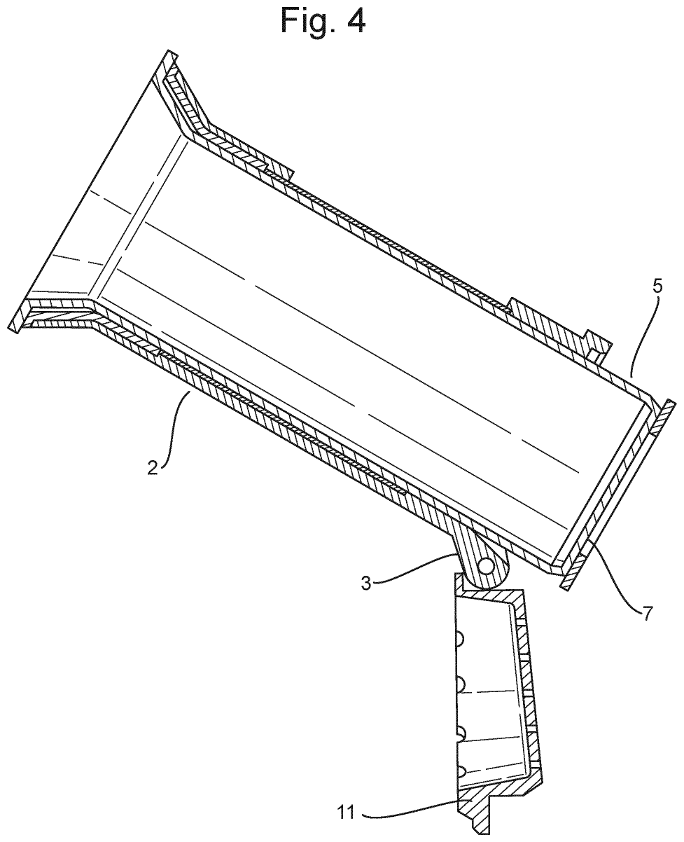

As can be seen in FIG. 3, the plunger opens the base as follows. As the plunger is further depressed to open the base 3, the upper end 13.1 of the sloped internal face 13 of the openable base is the first part of the door 11 to be acted upon by the plunger face 7. This therefore causes the friction fit closure 10 to be overcome. This is facilitated because this end 13.1 is adjacent to the closure means 10 and the force exerted by the plunger is transferred directly to the area of the closing means. The door 11 is thus opened through the action of the plunger face 7 pushing against the inner face 13 of the openable base. Although the infusible material is not shown in the Figures it will be appreciated by the skilled person that in the presence of infusible material the pressure from the plunger is transferred to the openable base via the compressed puck of infusible material and the upper end of the sloped internal face of the openable base will be acted upon by the force from the puck itself. The friction fit closure is therefore overcome, and the door is opened through the action of the puck pushing against the inner face of the openable base.

As can be seen in FIG. 4, when the plunger 5 is fully depressed, the door 11 is open and the plunger face 7 protrudes through the opened base 3 of the brew chamber 2 to facilitate rinsing and removal of any final remains of the infusion material from the plunger 5.

It will therefore be appreciated that the brewing device allows for ejection of spent material cleanly, simply and effectively.

1. A beverage brewing device comprising:
a brew chamber comprising at least one water permeable portion and an openable base; and
a plunger comprising a plunger face corresponding to an internal shape of the brew chamber;
wherein the openable base is openable by action of the plunger.

2. The beverage brewing device of claim 1, wherein the brew chamber is cylindrical.

3. The beverage brewing device of claim 1, wherein the brew chamber has a length of from 5-20 cm.

4. The beverage brewing device of claim 1, wherein the at least one water permeable portion is formed by apertures or windows in at least one wall of the brew chamber covered with foraminous material.

5. The beverage brewing device of claim 1, wherein the at least one water permeable portion is formed from openings.

6. The beverage brewing device of claim 5, wherein the openings are pores, perforations, holes, or a combination thereof.

7. The beverage brewing device of claim 1, wherein a length of the at least one water permeable portion is from 10-75% of a length of the brew chamber.

8. The beverage brewing device (1) of claim 1, wherein a length of the plunger is greater than a length of the brew chamber.

9. The beverage brewing device of claim 1, wherein the openable base comprises a door.

10. The beverage brewing device of claim 9, wherein the door is held closed by means of a friction fit along a surface.

11. The beverage brewing device (1) of claim 10, wherein the openable base further comprises a hinge that is coupled to the door.

12. The beverage brewing device of claim 11, wherein the hinge is positioned opposite the surface.

13. The beverage brewing device of claim 10, wherein an internal face of the openable base is sloped.

14. The beverage brewing device of claim 13, wherein the internal face slopes downwards away from the surface.

15. The beverage brewing device of claim 1, wherein the openable base comprises openings.

16. A beverage brewing device comprising:
a brew chamber having a first length, the brew chamber comprising:
a first end having a first opening,
a second end having a second opening,
a hinge located at the second end,
a door pivotably coupled to the hinge, the door operable between a first position where the door is not positioned in the second opening and a second position where the door is positioned in the second opening, the door comprising a plurality of holes that are each configured to facilitate fluid passage out of the brew chamber when the door is in the second position, and
a water permeable portion located between the first end and the second end, the water permeable portion configured to facilitate fluid passage through the brew chamber; and
a plunger having a second length greater than the first length, the plunger configured to be received within the first opening and selectively repositioned within the brew chamber.

17. The beverage brewing device of claim 16, wherein:
the brew chamber is cylindrical;
the water permeable portion comprises:
a window, and
a filter material positioned over the window;
the plunger is tubular; and
the plunger comprises an annular seal that is configured to form a seal with the brew chamber when the plunger is received within the first opening, the annular seal configured to facilitate repositioning of the plunger within the brew chamber.

18. The beverage brewing device of claim 16, wherein:
the plunger comprises a plunger face that is brought into confronting relation with the door when the door is in the second position and the plunger is received within the first opening and repositioned towards the door, the plunger face disposed along a first plane; and
the door comprises a door face and is configured such that the door face is disposed along a second plane when the door is in the second position, the second plane angled relative to the first plane.

19. A beverage brewing device comprising:
a brew chamber being cylindrical and having a first length, the brew chamber comprising:
a first end having a first opening,
a second end having a second opening, and
a water permeable portion located between the first end and the second end, the water permeable portion comprising:
a window configured to facilitate fluid passage through the brew chamber, and
a filter material positioned over the window; and
a plunger being tubular and having a second length greater than the first length, the plunger configured to be received within the first opening and selectively repositioned within the brew chamber, the plunger comprising an annular seal configured to form a seal with the brew chamber when the plunger is received within the first opening, the annular seal configured to facilitate repositioning of the plunger within the brew chamber.

20. The beverage brewing device of claim 19, wherein:
the water permeable portion has a third length that is from 20-50% of the first length;
a first portion of the brew chamber extends between the first end and the water permeable portion; and
a second portion of the brew chamber extends between the second end and the water permeable portion.
